(19) United States
(12) Patent Application Publication
(10) Pub. No.: US 2025/0069280 A1
(43) Pub. Date: Feb. 27, 2025

(54) IMAGE GENERATION METHOD AND APPARATUS, AND DEVICE AND MEDIUM

(71) Applicants: IEIT SYSTEMS CO., LTD., Jinan, Shandong (CN); INSPUR ELECTRONIC INFORMATION INDUSTRY CO., LTD., Jinan, Shandong (CN)

(72) Inventors: Yaqian ZHAO, Jinan, Shandong (CN); Lu LIU, Jinan, Shandong (CN); Rengang LI, Jinan, Shandong (CN); Zhenhua GUO, Jinan, Shandong (CN); Ruidong YAN, Jinan, Shandong (CN); Cong XU, Jinan, Shandong (CN); Liang JIN, Jinan, Shandong (CN)

(21) Appl. No.: 18/724,633

(22) PCT Filed: Sep. 28, 2022
(86) PCT No.: PCT/CN2022/122298

§ 371 Date: Jun. 27, 2024

(30) Foreign Application Priority Data
May 20, 2022 (CN) 202210546381.8

(51) Int. Cl. G06T 11/00; G06F 16/951; G06F 40/279; G06F 40/30; G06V 10/74; G06V 10/774; G06V 10/776; G06V 10/82

(52) U.S. Cl. CPC G06T 11/00; G06F 16/951; G06F 40/279; G06F 40/30; G06V 10/74; G06V 10/774; G06V 10/776; G06V 10/82

(57) ABSTRACT

An image generating method and apparatus, and a device and a medium are disclosed. The method comprises: acquiring weakly correlated image-text data pairs, and creating an image-text data set according to the weakly correlated image-text data pairs, wherein the weakly correlated image-text data pairs are image-text data pairs in which images and texts have weak correlations (S11); training, by using the image-text data set, an image generation model which is preconstructed on the basis of an adversarial network, so as to obtain a trained image generation model, wherein the image generation model includes a generator for generating an image, and a discriminator for identifying the authenticity of the image and calculating a corresponding loss value (S12); and after when text data to be processed has been acquired, generating, by using the trained image generation model, an image corresponding to the said text data (S13).

### CROSS REFERENCE TO RELEVANT APPLICATIONS

The present application claims the priority of the Chinese patent application filed on May 20, 2022 before the Chinese Patent Office with the application number of 202210546381.8 and the title of “IMAGE GENERATION METHOD AND APPARATUS, AND DEVICE AND MEDIUM”. which is incorporated herein in its entirety by reference.

### TECHNICAL FIELD

The present application relates to the field of artificial intelligence, and particularly relates to an image generation method, an apparatus, a device and a medium.

### BACKGROUND

Text-to-Image refers to generating semantically consistent and visually realistic images based on given text description. The commonly used method is to study semantic alignment of different statistic attributes between visual information and linguistic information, characterize the strong correlation between the text description and generated images, and increase the realism of generated images, based on pixel convolutional neural network (pixelCNN), approximate Langevin sampling, variational autoencoder and generative adversarial network (GAN). An attention GAN (AttnGAN) of a multistage fine-grained text generation network architecture based on GAN generates fine-grained image details by focusing on the subject words in the text description, and obtains more realistic generated image details. Since the AttnGAN method, the multistage text-to-image generation method have developed a series of object-driven hierarchical text-to-image generation methods. In these methods, generally, the semantic layout (for example, object bounding boxes, segmentation masks, or combinations) is firstly inferred based on the text description, and then an image is generated based on the layout. The hierarchical image generation method facilitates the fine-grained alignment of text and information in the image. However, the multistage method is difficult to apply in real world scenarios, and also requires more fine-grained semantic object labels to train the model.

Although the text-to-image generation technology has gained phased success, there is still a long way to go before practical application. In academic research, text-to-image sample pairs used by researchers are strong-correlated description, there is a relatively direct semantic correspondence between the text and the generated images. However, in real life, when an image is described by using natural language, the human brain may insinuate the images corresponding to the implicit meanings in the language, rather than strongly correlated image described in the text, so the images generated by using the existing image generation method are not fit the actual life scenarios.

As can be seen from the above, during the GAN-based Text-to-Image generation, how to avoid the situation in which current text-to-image is not close to real life scenarios and the image generation process is difficult to implement due to the traditional image generation method is problem to be solved in the field.

### SUMMARY

In view of this, an objective of the present application is to provide an image generation method, an apparatus, a device and a medium, which may train the image generation model based on image-text data with weak correlation between text and an image, and complete text-to-image more close to the real life scenario based on the image generation model, thereby solving the situation that the conventional image generation process may not be easily and practically implemented. The solution is as follows.

In a first aspect, the present application discloses an image generation method, including:

acquiring weakly correlated image-text data pairs, and creating an image-text dataset based on the weakly correlated image-text data pairs, where the weakly correlated image-text data pairs are image-text data pairs with weak correlation between an image and text a;

training an image generation model pre-constructed based on an adversarial network by using the image-text dataset, and obtaining a trained image generation model, where the image generation model includes a generator for generating an image and a discriminator for discriminating authenticity of an image and calculating a corresponding loss value; and

generating an image corresponding to to-be-processed text data by using the trained image generation model when the to-be-processed text datum is acquired.

In embodiments of the present application, the training the image generation model pre-constructed based on the adversarial network, by using the image-text dataset includes:

determining a target text from the image-text dataset and generating a corresponding first target image based on the target text by using the generator of the image generation model;

determining a second target image corresponding to the target text from the image-text dataset by using the discriminator of the image generation model, performing a global feature comparison and a local feature comparison between the first target image and the second target image to obtain corresponding feature comparison results, and determining an adversarial loss value corresponding to the first target image based on the feature comparison results, where the adversarial loss value is a probability value for indicating authenticity of an image; and

determining an authenticity discrimination result of the first target image based on the adversarial loss value.

In embodiments of the present application, the generating the corresponding first target image based on the target text includes:

processing the target text by using a predetermined language processing tool, to determine a target entity in the target text;

determining a to-be-expanded entity based on the target entity by using a predetermined knowledge-graph technique, and constructing a corresponding entity candidate set based on the to-be-expanded entity and the target entity;

inputting the target text and the entity candidate set into a predetermined conversion model, to obtain text semantic embedding and entity semantic embedding which are output by the conversion model and correspond to the target text and the entity candidate set respectively; and

generating the first target image based on predetermined random noise, the text semantic embedding and the entity semantic embedding.

In embodiments of the present application, the generating the first target image based on the predetermined random noise, the text semantic embedding and the entity semantic embedding includes:

inputting the predetermined random noise, the text semantic embedding and the entity semantic embedding into a predetermined multilayer perceptron, to obtain an affine transformation parameter;

determining a target hidden-layer feature value based on the affine transformation parameter, and adjusting a current hidden-layer feature value to the target hidden-layer feature value, to obtain a global condition for constraining a pixel value of the generated first target image; and

generating the first target image based on the global condition by using a pre-connected up-sampling layer.

In embodiments of the present application, the image generation method further includes:

calculating a loss value of the generator based on a predetermined batch size of text, an image corresponding to the text and an entity candidate set corresponding to the text by using a predetermined first loss function;

calculating a loss value of the discriminator based on the same batch of text, the image corresponding to the text and the entity candidate set corresponding to the text by using a predetermined second loss function; and

determining a network parameter affecting the loss value of the generator and the loss value of the discriminator, and optimizing and updating the network parameter by using a predetermined optimizer.

In embodiments of the present application,, after the optimizing and updating the network parameter by using the predetermined optimizer, the method further includes:

recording a number of times of optimizing and updating by using a predetermined counter;

determining whether the number of times of optimizing and updating satisfies a predetermined target number of times of optimizing; and

terminating the training when the number of times of optimizing and updating satisfies the predetermined target number of times of optimizing.

In embodiments of the present application, the acquiring the weakly correlated image-text data pairs includes:

acquiring information about a public social networking website, and determining a target website based on information about the public social networking website; and

crawling weakly correlated image-text data in the target website, and generating the weakly correlated image-text data pairs based on the weakly correlated image-text data.

In a second aspect, the present application discloses an image generation apparatus including:

a dataset creation module configured for acquiring weakly correlated image-text data pairs, and creating an image-text dataset based on the weakly correlated image-text data pairs, where the weakly correlated image-text data pairs are image-text data pairs with weak correlation between an image and text;

a model training module configured for training an image generation model pre-constructed based on an adversarial network by using the image-text dataset and obtaining a trained image generation model, where the image generation model includes a generator for generating an image and a discriminator for discriminating authenticity of an image and calculating a corresponding loss value; and

an image generation module configured for generating an image corresponding to the to-be-processed text data by using the trained image generation model when the to-be-processed text data is acquired.

In a third aspect, the present application discloses an electronic device, including:

a memory configured for storing a computer program; and

a processor configured for execute the computer program to implement the above image generation method.

In a fourth aspect, the present application discloses a computer storage medium storing a computer program; and the computer program, when executed by a processor, implements steps of the above image generation method.

In the present application, a weakly correlated image-text data pair is firstly acquired, and an image-text dataset is created based on to the weakly correlated image-text data pair, the weakly correlated image-text data pair is an image-text data pair with weak correlation between an image and text. Then, an image generation model pre-constructed is trained by the image-text dataset based on an adversarial network, to obtain a trained image generation model. The image generation model includes a generator for generating an image and a discriminator for discriminating the authenticity of the image and calculating a corresponding loss value. Finally, an image corresponding to the to-be-processed text data is generated by using the trained image generation model when the to-be-processed text data is acquired. Accordingly, the present method is based on the GAN technology, creates the image-text dataset by using the acquired weakly correlated image-text data pair, and trains the generator and the discriminator in the image generation model, in order to use the trained image generation model for image generation. The present method abandons the conventional image generation methods of using image-text data with strong correlation and a multistage generator, and instead uses image-text data with weak correlation between the text and the image and a single-stage end-to-end training method, so that the generated predictive images are more close to the real life scenarios and may be easily and practically implemented. In addition, because the present method is improved for the strong correlation between the image and text in the current image generation method, it may be used to instruct the generation of artistic and abstract images, makes up for the disadvantage that the current text-to-image generation method is only applicable to the experimental environment, and may be widely used in the fields of image editing, image artistic creation, image generation and so on.

The above description is merely a summary of the technical solution of the present application. In order to more clearly know the elements of the present application to enable the implementation according to the contents of the description, and in order to make the above and other purposes, features and advantages of the present application more apparent and understandable, the embodiments of the present application are provided below.

### BRIEF DESCRIPTION OF THE DRAWINGS

In order to more clearly illustrate the technical solutions of the embodiments of the present application or the conventional technology, the figures that are required to describe the embodiments or the conventional technology will be briefly described below. Apparently, the figures that are described below are merely embodiments of the present application, and a person skilled in the art can obtain other figures according to the provided figures without paying creative work.

FIG. 1 is a flow chart of an image generation method according to some embodiments of the present application;

FIG. 2 is a flow chart of a model training method according to some embodiments of the present application;

FIG. 3 is a schematic diagram of image generation for a generator according to some embodiments of the present application;

FIG. 4 is a schematic flow chart according to some embodiments of the present application;

FIG. 5 is a schematic diagram of a discrimination process for a discriminator according to some embodiments of the present application;

FIG. 6 is a schematic structural diagram of an image generation apparatus according to some embodiments of the present application;

FIG. 7 is a structural diagram of an electronic device according to some embodiments of the present application; and

FIG. 8 schematically shows a non-transitory readable storage medium for maintaining or carrying program code implementing the method according to the present application.

### DETAILED DESCRIPTION

The technical solutions of the embodiments of the present application will be clearly and completely described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

In the image generation method in the conventional technology, image-text data with strong correlation and a multistage generator are used. However, the strong correlation may not be practically implemented, because human descriptions of matters are not straightforward, but full of imagination and association. In the present application, image-text data with weak correlation between the text and the image and a single-stage end-to-end training method are used, so that the generated predictive images are more close to the real life scenarios, may be more easily and practically implemented, and may be widely used in the fields of image editing, image artistic creation, image generation and so on.

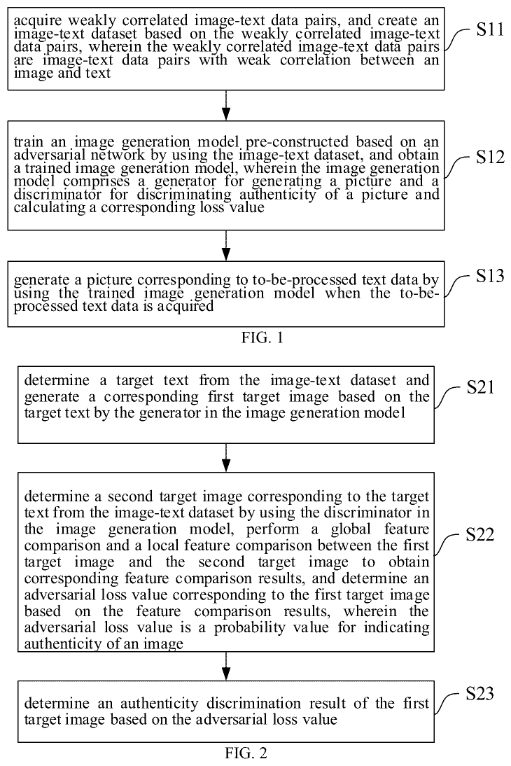

An embodiment of the present application discloses an image generation method. Referring to FIG. 1, the method includes S11-S13.

In step S11, weakly correlated image-text data pairs are acquired, and an image-text dataset is created based on the weakly correlated image-text data pairs, where the weakly correlated image-text data pairs are image-text data pairs with weak correlation between an image and text.

In the present embodiment, the acquiring the weakly correlated image-text data pairs may include: acquiring information about public social networking websites, determining a target website by using the information about public social networking websites; crawling weakly correlated image-text data in the target website, and generating the weakly correlated image-text data pairs by using the weakly correlated image-text data. It may be understood that the weakly correlated image-text data pairs in the present embodiment may be crawled from public social networking sites. Furthermore, in an implementation, the target website may be firstly determined according based on the acquired information about public social-networking sites, and then the weakly correlated image-text data of the target website may be crawled. The information about public social networking sites may be a link to a public social networking site.

In step S12, an image generation model pre-constructed is trained based on an adversarial network by using the image-text dataset, to obtain a trained image generation model, where the image generation model includes a generator for generating an image and a discriminator for discriminating authenticity of the image and calculating a corresponding loss value.

It may be understood that the image generation model in the embodiment is pre-constructed based on an adversarial network (i.e., GAN), and the image generation model includes a generator G and a discriminator D). It should be noted that the corresponding loss value calculable by the discriminator in the embodiment may be the adversarial loss value representing a probability value of image authenticity and a loss value L^{D} of the discriminator.

In step S13, an image corresponding to to-be-processed text data is generated by using the trained image generation model when the to-be-processed text data is acquired.

It may be understood that, after the image generation model is trained to obtain the corresponding image generation model in S12, the image generation model is also tested, and in an implementation, image-text data in the image-text dataset may also be used for testing. After passing the test, the image generation model may be applied, i.e., after the to-be-processed text data is acquired, an image corresponding to the to-be-processed text data is generated by using the trained image generation model

In the embodiment, weakly correlated image-text data pairs are firstly acquired, and an image-text dataset is created based on the weakly correlated image-text data pairs, where the weakly correlated image-text data pairs are image-text data pairs with weak correlation between an image and text. Then, an image generation model pre-constructed is trained based on an adversarial network by using the image-text dataset, to obtain a trained image generation model, where the image generation model includes a generator for generating an image and a discriminator for discriminating the authenticity of an image and calculating a corresponding loss value. Finally, an image corresponding to to-be-processed text datum is generated by using the trained image generation model when the to-be-processed text data is acquired. In the method, the image generation model is trained by using the image-text data pairs with weak correlation in the image-text dataset, so that images are generated by the trained image generation model. During the image generation and the model training, image-text data with strong correlation and a multistage generator in the conventional image generation method are abandoned, and instead image-text data with weak correlation between the text and the image are used to instruct generation of fine-grained images, and a single-stage end-to-end training method is used, so that the generated predictive images are more close to real life scenarios, and easily and practically implemented. In addition, because the method is improved for the strong correlation between the text and the image in the current image generation method, it may be used to instruct the generation of artistic and abstract images, make up for the disadvantage that the current text-to-image generation method is only applicable to experimentation environments, and may be widely used in the fields of image editing, image artistic creation, image generation and so on.

FIG. 2 is a flow chart of a model training method according to an embodiment of the present application. Referring to FIG. 2, the method includes S21-S23.

In step S21, a target text is determined from the image-text dataset, a corresponding first target image is generated based on the target text by using the generator in the image generation model.

The generating the corresponding first target image based on the target text may include: processing the target text by using a predetermined language processing tool to determine a target entity in the target text; determining a to-be-expanded entity based on the target entity by using a predetermined knowledge-graph technique, and constructing a corresponding entity candidate set by using the to-be-expanded entity and the target entity; inputting the target text and the entity candidate set into a predetermined conversion model, to obtain text semantic embedding and entity semantic embedding corresponding to the target text and the entity candidate set respectively, outputted by the conversion model and; and generating the first target image based on predetermined random noise, the text semantic embedding and the entity semantic embedding.

In the embodiment, after the target text is determined from the image-text dataset, the target text is processed to extract the target entity in the target text. In an implementation, if the target text S is “happy birthday”, then the target entity k that may be extracted is “birthday”. Subsequently, the to-be-expanded entity is determined to be “making a wish” by using the predetermined knowledge-graph technique. Subsequently, a corresponding entity candidate set is constructed by using the to-be-expanded entity and the target entity, i.e., the entity candidate set may be [birthday, making a wish]. Subsequently, “happy birthday” and [birthday, making a wish] are input into a pre-trained BERT model, to obtain the corresponding embeddings, i.e., the text semantic embedding eₛ={eₛ₁, eₛ₂, . . . eₛₘ} and the entity semantic embedding eₖ={eₖ₁, eₖ₂, . . . eₖₙ}. Finally, in combination with the random noise z, eₛ, eₖ and z are connected by using a predetermined connection function, to generate the first target image by using the connected eₛ, eₖ and z. It should be noted that the predetermined connection function includes, but is not limited to, the concatenate function and the concat function.

It can be understood that, in the embodiment, entities are expanded by using the predetermined knowledge-graph technique, to establish an association with the main content in the image corresponding to the target text at the semantic level. Finally, the image generation model is trained by using the expanded entity candidate set, which greatly improve the semantic accuracy of the image generation, and make the generated image more close to the real life.

In the embodiment, the knowledge-graph technique includes, but is not limited to, a knowledge-graph technique based on Wikipedia knowledge base, the language processing tool includes, but is not limited to, spaCy, and the predetermined conversion model includes, but is not limited to, a BERT model.

In the embodiment, the generating the first target image based on the predetermined random noise, the text semantic embedding and the entity semantic embedding may include inputting the predetermined random noise, the text semantic embedding and the entity semantic embedding into a predetermined multilayer perceptron, to obtain an affine-transformation parameter; determining a target hidden-layer feature value by using the affine-transformation parameter, and adjusting a current hidden-layer feature value to the target hidden-layer feature value, to obtain a global condition for constraining pixel values of the generated first target image; and generating the first target image based on the global condition by using a pre-connected up-sampling layer. It may be understood that the above process of generating the first target image is completed by the generator, and the first target image refers to the image corresponding to the target text generated by the generator.

In the embodiment, the generator includes an affine transformation module configured for directing the generation of the first target image using a set of the random noise, the text semantic embedding and the entity semantic embedding [z, eₛ, eₖ]. In an implementation, after z, eₛ and eₖ are connected by using the predetermined connection function, they are input into an MLP layer (i.e., a multilayer perceptron) to obtain affine transformation parameters γⱼ and βⱼ. The target hidden-layer feature value hⱼ is calculated by using a predetermined formula, and the hidden-layer feature value is adjusted to obtain the global condition for the current image generation; and the first target image is generated based on the global condition by using the pre-connected up-sampling layer. The hidden-layer feature value may be directly modified to modify as the target hidden-layer feature value hⱼ. After the hidden-layer feature value is adjusted, a loss function may be used to constrain the pixels of the generated image. In an implementation, the type of the loss function includes, but is not limited to, an L1 norm loss function and an L2 norm loss function. If an L2 norm loss function is used, then the corresponding loss function formula may be L_{img}^{G}∥xᵢ−G(zⱼ, eₖ, eₖ)∥₂², where G(zᵢ, eₛ, eₖ) is the generator, and xᵢ is a pixel value of a second target image corresponding to the target text in the image-text dataset.

The entity semantic embedding ex may be used as an additional modulation parameter of a local region, so that the feature generation in the local region is controlled. The formula for calculating the target hidden-layer feature value hⱼ may be

$${h}_{j}^{‘} = {γ}_{j} ( concat ( z , {e}_{s} , {e}_{k} ) ) \times \frac{{h}_{j} - μ}{σ} + {β}_{j} ( concat ( z , {e}_{s} , {e}_{k} ) ) ,$$

where μ is a mean value of data, and σ is a standard deviation of data.

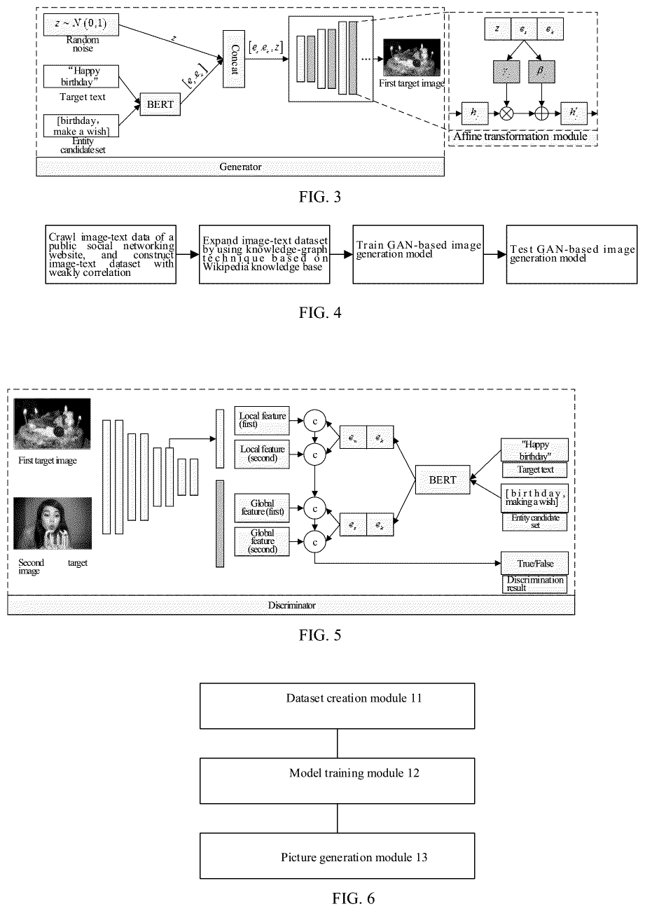

FIG. 3 is a schematic diagram of image generation by the generator, which shows the process of generate a first target image by the generator using the random noise, the target text and the entity candidate set. After the target text and the entity candidate set corresponding to the target text are input into the BERT model, the text semantic embedding eₛ and the entity semantic embedding eₖ corresponding to the target text and the entity candidate set are generated, the predetermined random noise z, the text semantic embedding eₛ and the entity semantic embedding eₖ are connected by using the concat function, and are processed correspondingly by the affine transformation method in the affine transformation module. Finally, the first target image is generated.

In another implementation of the present disclosure, after the image-text dataset is created, the image-text dataset is directly expanded by using the knowledge-graph technique based on the Wikipedia knowledge base, and the image generation model is then trained by using the expanded image-text dataset. FIG. 4 is a schematic flow chart of an implementation of the present application, image-text data of a public social networking website is firstly crawled, to construct the image-text dataset with weak correlation, the image-text dataset is expanded by using the knowledge-graph technique based on the Wikipedia knowledge base, the image generation model is trained by using the expanded image-text dataset, after the training of the image generation model is completed, the model is tested, and finally the image generation model may be applied.

In step S22, a second target image corresponding to the target text is determined from the image-text dataset by using the discriminator in the image generation model, a global feature comparison and a local feature comparison are performed on the first target image and the second target image, to obtain corresponding feature comparison results, and an adversarial loss value corresponding to the first target image is determined based on the feature comparison results. The adversarial loss value is a probability value for indicating authenticity of the image.

In the embodiment, the image generation method may further include: calculating a loss value of the generator based on a predetermined batch size of text, images corresponding to the text and an entity candidate set corresponding to the text by using a predetermined first loss function; calculating a loss value of the discriminator based on the same batch of text, the images corresponding to the text and the entity candidate set corresponding to the text by using a predetermined second loss function; determining a network parameter which affects the loss value of the generator and the loss value of the discriminator, and optimizing and updating the network parameter by using a predetermined optimizer.

In an implementation, images in the image-text dataset may be expressed as {x₁, x₂, . . . , xₙ}, corresponding text may be expressed as {s₁, s₂, . . . , sₙ}, an entity candidate set may be expressed as {{k₁, k₂, . . . }, {k₁, k₂, . . . }, . . . }, and the selected batch size of text, the images corresponding to the text and the entity candidate set corresponding to the text may be expressed as {(x₁, s₁, k₁, k₂, . . . ), (x₂, s₂, k₁, k₂, . . . )}.

It may be understood that the discriminator determines the authenticity of the first target image after the first target image generated by the generator is acquired. Based on the principle of convolutional neural network, the underlying layer of the discriminator reduces the space dimensions to 16*16 by using a plurality of down-sampling layers, determine image features by using a plurality of down-sampling layers and a global pooling layer, compares the image features, and connects two projection heads, where one of the projection heads is configured for calculating the adversarial loss value L_{adv}(D, G), and the other is configured for calculating the loss values Lₛₑₙₜ, L_{img} and L_{word}.

In an implementation, the formula for calculating the adversarial loss value may be

min max L_{adv}(D, G)=E_{x˜p}_{_{data}}(log D(x))+E_{x˜p}_{_{z}}_{(z)}[log(1−D)(G(z)))],

where E_{x˜p}_{_{data}} and E_{x˜p}_{_{data}} represent probabilities of true data and generated data.

In an implementation, the loss value L_{D} of the discriminator=Lₛₑₙₜ+L_{img}+L_{word}+L_{adv}, Where functions for calculating the loss values Lₛₑₙₜ, L_{img} and L_{word} may be:

$${L}_{sent} ( {x}_{i} , {s}_{i} , {k}_{i} ) = - log \frac{exp ( cos ( {f}_{ing} ( G ( {z}_{i} , {s}_{i} , {k}_{i} ) ) , {f}_{ing} ( {s}_{i} , {k}_{i} ) ) / τ )}{{\sum }_{j = 1}^{M} exp ( cos ( {f}_{ing} ( G ( {z}_{i} , {s}_{i} , {k}_{i} ) ) , {f}_{ing} ( {s}_{j} , {k}_{j} ) ) / τ )} ;$$

$${L}_{ing} ( {x}_{i} , G ( {z}_{i} , {s}_{i} , {k}_{i} ) ) = - log \frac{exp ( {S}_{ing} ( {x}_{i} , G ( {z}_{i} , {s}_{i} , {k}_{i} ) ) )}{{\sum }_{j = 1}^{M} exp ( {S}_{ing} ( {x}_{i} , G ( {z}_{j} , {s}_{j} , {k}_{j} ) ) )} ;$$

$$and$$

$${L}_{word} ( {x}_{i} , {s}_{i} , {k}_{i} ) = - log \frac{exp ( {S}_{word} ( {x}_{i} , {s}_{i} , {k}_{i} ) )}{{\sum }_{j = 1}^{M} exp ( {S}_{word} ( {x}_{j} , {s}_{j} , {k}_{j} ) )}$$

where Lₛₑₙₜ is a comparison loss function between the target text and the first target image, L_{img} is a comparison loss function between the first target image and the second target image, L_{word} is a comparison loss function between the first target image and the entity, τ is a temperature coefficient in comparison loss, ƒ is a function layer related to img or txt in the image generation model, and S_{X}(x, s, k)=cos(ƒ_{img}(x), ƒₛₑₙₜ(s, k)/τ.

It should be noted that the optimizing and updating the network parameter by using the predetermined optimizer may include performing reverse gradient optimization on the network parameter by using an Adam optimizer.

In step S23, an authenticity discrimination result of the first target image is determined based on the adversarial loss value.

It may be understood that, after the adversarial loss value is determined, the authenticity result of the first target image may be determined based on the adversarial loss value.

FIG. 5 is a schematic diagram of the discriminating process of the discriminator, which shows the process of discriminating the authenticity of the image by the discriminator. After the first target image and the second target image are acquired, a global feature comparison and a local feature comparison are performed to obtain corresponding feature comparison results, a probability value (“c” in FIG. 5) corresponding to the adversarial loss value of the first target image is determined based on the feature comparison results, and finally the authenticity of the image is determined based on the adversarial loss value. In the figure, e_{w} refers to the semantic embedding corresponding to a certain entity in the entity candidate set.

In the embodiment, after the optimizing and updating the network parameter by using the predetermined optimizer, the method may further include: recording a number of times of optimizing and updating by using a predetermined counter; determining whether the number of times of optimizing and updating satisfies a predetermined target number of times of optimizing; and terminating the training if the number of times of optimizing and updating satisfies the predetermined target number of times of optimizing. In an implementation, the target number of times of optimizing may be set to 1 million; if the number of times of optimizing and updating satisfies 1 million, the training is stopped; and if the number of times of optimizing and updating does not satisfy 1 million, then the loss value of the generator is calculated by using the predetermined batch size of text, the images corresponding to the text and the entity candidate set corresponding to the text, the loss value of the discriminator is calculated by using the same batch of text, the images corresponding to the text and the entity candidate set corresponding to the text, the network parameter which affects the loss value of the generator and the loss value of the discriminator is determined, and the network parameter is optimized and updated by using the predetermined optimizer, until the number of times of optimizing and updating satisfies 1 million.

In the embodiment, the process of training the image generation model constructed based on the adversarial network is described in detail. The processes of training the generator and the discriminator is mainly described. The affine transformation method in which the generator uses the random noise, the text semantic embedding and the entity semantic embedding input to the affine-transformation module in the process of generating the target image, and a calculation method in which the adversarial loss value of the generator and the loss value of the discriminator are calculated are provided. Accordingly, the discriminator provided in the solution does not only has the function of discriminating the authenticity of the image, but also has the function of calculating the loss value as an encoder, which reduces the cumbersome process of the multistage generation in the application of the GAN technology in the conventional technology, makes up for the disadvantages of the conventional image generation method, and realizes the image generation model based on weak image-text correlation by using the multi-granularity comparison learning method which integrates inter-mode and cross-mode, thereby ensuring reasonableness of the image generation, and further facilitating practical implementations.

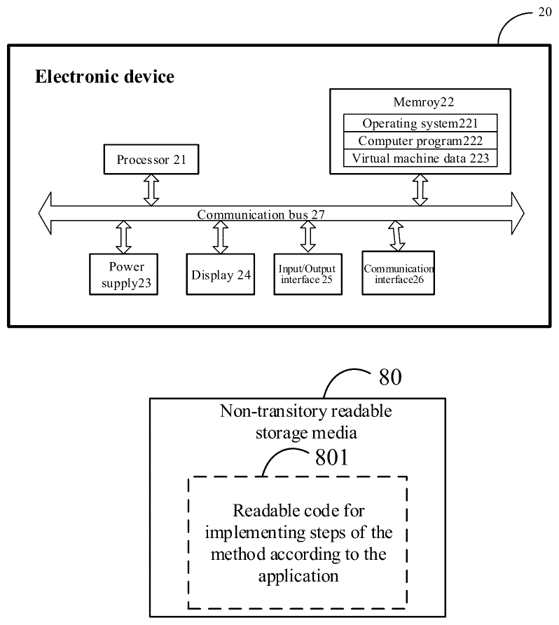

Referring to FIG. 6, an embodiment of the present application discloses an image generation apparatus which may include:

a dataset creation module 11 configured for acquiring weakly correlated image-text data pairs, and creating an image-text dataset based on the weakly correlated image-text data pairs, where the weakly correlated image-text data pairs are image-text data pairs with weak correlation between an image and text;

a model training module 12 configured for training an image generation model pre-constructed based on an adversarial network by using the image-text dataset, to obtain a trained image generation model, where the image generation model includes a generator for generating an image and a discriminator for discriminating authenticity of the image and calculating a corresponding loss value; and

an image generation module 13 configured for generating an image corresponding to the to-be-processed text data by using the trained image generation model when the to-be-processed text data is acquired.

In the present application, weakly correlated image-text data pairs are firstly acquired, and an image-text dataset is created based on the weakly correlated image-text data pairs, where the weakly correlated image-text data pairs are image-text data pairs with weak correlation between an image and text. An image generation model pre-constructed based on an adversarial network is trained by using the image-text dataset, to obtain a trained image generation model, where the image generation model includes a generator for generating an image and a discriminator for discriminating authenticity of an image and calculating a corresponding loss value. Finally, an image corresponding to to-be-processed text data is generated by using the trained image generation model when the to-be-processed text data is acquired. In this way, in the method, the image-text dataset is created by using the weakly correlated image-text data pairs, and the generator and the discriminator in the image generation model are trained based on the image-text dataset, to perform the image generation by the trained image generation model. The present method is based on the GAN technology. The generator and the discriminator in the image generation model are trained by the acquired weakly correlated image-text dataset, so that the trained image generation model is used to perform the image generation. The present method abandons image-text data with strong correlation and a multistage generator in the conventional image generation methods, but employs image-text data with weak correlation between the text and the image and a single-stage end-to-end training method, so that the generated predictive images are more close to the real life scenarios, and easily and practically implemented. In addition, because the present method is improved for the strong image-text correlation in the conventional image generation methods, it may be used to instruct the generation of artistic and abstract images, overcomes the disadvantage that the current text-to-image generation method is only applicable to experimentation environments, and may be widely used in the fields of image edition, image artistic creation, image generation and so on, In some embodiments, the model training module 12 includes:

a first target image generation unit configured for determining a target text from the image-text dataset and generating a corresponding first target image based on the target text by using the generator in the image generation model;

a target image discrimination unit configured for determining a second target image corresponding to the target text from the image-text dataset by using the discriminator in the image generation model, performing a global feature comparison and a local feature comparison between the first target image and the second target image to obtain corresponding feature comparison results, and determining an adversarial loss value corresponding to the first target image based on the feature comparison results, where the adversarial loss value is a probability value for indicating authenticity of the image; and

an authenticity determination unit configured for determining a discrimination result of the authenticity of the first target image based on the adversarial loss value.

In some embodiments, the target image generation unit includes:

an entity determination unit configured for processing the target text by using a predetermined language processing tool, to determine a target entity in the target text;

a candidate set expansion unit configured for determining a to-be-expanded entity by using a predetermined knowledge-graph technique based on the target entity, and constructing a corresponding entity candidate set by using the to-be-expanded entity and the target entity;

an embedding conversion unit configured for inputting the target text and the entity candidate set into a predetermined conversion model, to obtain a text semantic embedding and an entity semantic embedding that are output by the conversion model and correspond to the target text and the entity candidate set respectively; and

a second target image generation unit configured for generating a first target image based on a predetermined random noise, the text semantic embedding and the entity semantic embedding. In some embodiments, the second target image generation unit includes:

an affine transformation unit configured for inputting the predetermined random noise, the text semantic embedding and the entity semantic embedding into a predetermined multilayer perceptron, to obtain an affine transformation parameter;

a characteristic-value determining unit configured for determining a target hidden-layer characteristic value by using the affine-transformation parameter, and adjusting a current hidden-layer characteristic value to the target hidden-layer characteristic value, to obtain a global condition for constraining a pixel value of a generated first target image; and

a third target image generation unit configured for generating the first target image by using a preconnected up-sampling layer based on the global condition.

In some embodiments, the image generation apparatus further includes:

a first loss value determination unit configured for calculating a loss value of the generator by using a predetermined first loss function based on a predetermined batch size of text, an image corresponding to the text and a candidate set of entities corresponding to the text;

a second loss value determination unit configured for calculating a loss value of the discriminator by using a predetermined second loss function based on the same batch size of text, the image corresponding to the text and the candidate set of entities corresponding to the text; and

an optimization update unit configured for determining a network parameter affecting the loss value of the generator and the loss value of the discriminator, and optimizing and updating the network parameter by using a predetermined optimizer.

In some embodiments, the image generation apparatus further includes:

a number recording unit configured for recording a number of times of optimizing and updating by using a predetermined counter;

a number determination unit configured for determining whether the number of times of optimizing and updating satisfies a predetermined target number of times of optimizing; and

a training termination unit configured for terminating the training if the number of times of optimizing and updating satisfies the predetermined target number of times of optimizing.

In some embodiments, the dataset creation module 11 includes:

a website determination unit configured for acquiring information about public social networking websites and determining a target website based on the information about public social networking websites; and

a data crawling unit configured for crawling weakly correlated image-text data in the target website, and generating the weakly correlated image-text data pairs by using the weakly correlated image-text data.

Further, an embodiment of the present application further discloses an electronic device. FIG. 7 is a structural diagram of the electronic device 20 according to an exemplary embodiment, and the contents in FIG. 7 should not be considered as any limitation on the scope of application of the present application.

FIG. 7 is a schematic structural diagram of the electronic device 20 according to an embodiment of the present application. The electronic device 20 may include at least one processor 21, at least one memory 22, a power supply 23, a display screen 24, an input/output interface 25, a communication interface 26 and a communication bus 27. The memory 22 is configured for storing a computer program which is loaded and executed by the processor 21 to implement the relevant steps of the image generation method disclosed in any one of the above embodiments. In addition, the electronic device 20 in the present embodiment may be an electronic computer.

In the present embodiment, the power supply 23 is configured for supplying operating voltage to the hardware devices on the electronic device 20. The communication interface 26 may create a data transmission channel between the electronic device 20 and an external device, and the communication protocol that it follows is any communication protocol that may be applied to the technical solution of the present application, and is not limited herein. The input/output interface 25 is configured for acquiring external input data or outputting data to the outside, and its interface type may be selected according to application demands, and is not limited herein.

In addition, the memory 22, as the carrier for resource storage, may be a read-only memory, a random access memory, a magnetic disk, an optical disk and so on. The resource stored thereon may include an operating system 221, a computer program 222, virtual-machine data 223 and so on. The virtual-machine data 223 may include a wide variety of data. The storage may be transient storage or permanent storage.

The operating system 221 is configured for managing and controlling various hardware devices of the electronic device 20 and computer program 222, and may be Windows Server, Netware, Unix, Linux and so on. The computer program 222 may further include, in addition to a computer program that may be configured to accomplish the image generation method executed by the electronic device 20 disclosed in any one of the above embodiments, a computer program that may be configured to accomplish other tasks.

Further, the present application further discloses a non-transitory readable storage medium. The non-transitory readable storage medium described herein includes a random access memory (RAM), a memory, a read-only memory (ROM), an electrically programmable ROM, an electrically erasable programmable ROM, a register, a hard disk, a diskette, an optical disk or any other forms of storage medium well known in the art. The computer program, when executed by a processor, implements the above image generation method. The steps of the method may refer to the corresponding contents disclosed in the above embodiments, and are not repeated herein.

Each component embodiment of the present application may be implemented in hardware, or in software modules running on one or more processors, or a combination thereof. A person skilled in the art should understand that some or all of the functions of some or all of the components of the electronic device according to the embodiments of the present application may be implemented by using a microprocessor or a digital signal processor (DSP) in practice. The present application may also be implemented as apparatus program or device program (for example, computer program and a computer program product) for implementing part of or all of the methods described herein. Such programs for implementing the present application may be stored in a computer-readable medium, or may be in the form of one or more signals. Such signals may be downloaded from an Internet website, or provided on a carrier signal, or provided in any other forms.

For example, the electronic device that may implement the method according to the present application may traditionally include: a processor and a computer program product or computer-readable medium in the form of a memory. The memory may be an electronic memory such as a flash memory, an EEPROM (electrically erasable programmable read-only memory), an EPROM, a hard disk and a ROM. The memory has storage space for program code for implementing any steps of the above method. For example, the storage space for program code may contain individual program codes for implementing various steps of the above method. Those program codes may be read from one or more computer program products or be written into the one or more computer program products. These computer program products include program code carriers such as a hard disk, a compact disk (CD), a memory card or a floppy disk. Such computer program products are typically non-transitory readable storage mediums 80 as shown in FIG. 8. The non-transitory readable storage medium 80 may have storage segments or storage spaces with similar arrangement to the memory in the electronic device. The program codes may, for example, be compressed in an appropriate form. Generally, the non-transitory readable storage medium contains computer-readable code 801, i.e., code that may be read by, for example, a processor. The code causes the electronic device to implement various steps of the above method when run by the electronic device.

Various embodiments in the description are described in a progressive manner, each of the embodiments focuses on the differences with the other embodiments. The same or similar parts of various embodiments may be referred to each other. For the devices disclosed in the embodiments, because they correspond to the methods disclosed in the embodiments, they are described simply. For relevant parts, please refer to the description of the methods. A person skilled in the art may further understand that the units and the algorithm steps of various examples described with reference to the embodiments disclosed herein may be implemented by using electronic hardware, computer software or a combination thereof. In order to clearly explain the interchangeability between the hardware and the software, the composition and the steps of various examples are generally described in the above description according to the functions. Whether those functions are executed by hardware or software depends on the applications and the design constraints of the technical solution. A person skilled in the art may use different methods to implement the described functions for each application, but the implementations should not be considered outside the scope of the present application.

The steps of the method or algorithm described with reference to the embodiments disclosed herein may be implemented directly by using hardware, a software module executed by a processor or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium well known in the art.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

The image generation method, the image generation apparatus, the device and the storage medium provided in the present application are described in detail above. Examples are applied to explain the principle and the implementations of the present application herein. The above embodiments are only used to help understand the method of the present application and the core concept thereof. Moreover, for a person skilled in the art, according to the concept of the present application, there may be changes in the implementation and application scope. In conclusion, the contents of the specification should not be understood as limiting the present application.

1. An image generation method, comprising:
acquiring weakly correlated image-text data pairs, and creating an image-text dataset based on the weakly correlated image-text data pairs, wherein the weakly correlated image-text data pairs are image-text data pairs with weak correlation between an image and text;
training an image generation model pre-constructed based on an adversarial network by using the image-text dataset, and obtaining a trained image generation model, wherein the image generation model comprises a generator for generating an image and a discriminator for discriminating authenticity of an image and calculating a corresponding loss value; and
generating an image corresponding to to-be-processed text data by using the trained image generation model when the to-be-processed text data is acquired.

2. The image generation method according to claim 1, wherein the training the image generation model pre-constructed based on the adversarial network by using the image-text dataset comprises:
determining a target text from the image-text dataset and generating a corresponding first target image based on the target text by using the generator in the image generation model;
determining a second target image corresponding to the target text from the image-text dataset performing a global feature comparison and a local feature comparison between the first target image and the second target image to obtain corresponding feature comparison results, and determining an adversarial loss value corresponding to the first target image based on the feature comparison results by using the discriminator in the image generation model, wherein the adversarial loss value is a probability value for indicating authenticity of an image; and
determining an authenticity discrimination result of the first target image based on the adversarial loss value.

3. The image generation method according to claim 2, wherein the generating the corresponding first target image based on the target text comprises:
processing the target text by using a predetermined language processing tool to determine a target entity in the target text;
determining a to-be-expanded entity based on the target entity by using a predetermined knowledge-graph technique, and constructing a corresponding entity candidate set based on the to-be-expanded entity and the target entity;
inputting the target text and the entity candidate set into a predetermined conversion model to obtain text semantic embedding and entity semantic embedding which are output by the conversion model and correspond to the target text and the entity candidate set respectively; and
generating the first target image based on predetermined random noise, the text semantic embedding and the entity semantic embedding.

4. The image generation method according to claim 3, wherein the generating the first target image based on the predetermined random noise, the text semantic embedding and the entity semantic embedding comprises:
inputting the predetermined random noise, the text semantic embedding and the entity semantic embedding into a predetermined multilayer perceptron, to obtain an affine transformation parameter;
determining a target hidden-layer feature value based on the affine transformation parameter, and adjusting a current hidden-layer feature value to the target hidden-layer feature value, to obtain a global condition for constraining a pixel value of the generated first target image; and
generating the first target image based on the global condition by using a pre-connected up-sampling layer.

5. The image generation method according to claim 3, wherein the method further comprises:
calculating a loss value of the generator based on a predetermined batch size of text, an image corresponding to the text and an entity candidate set corresponding to the text by using a predetermined first loss function;
calculating a loss value of the discriminator based on the same batch of text, the image corresponding to the text and the entity candidate set corresponding to the text by using a predetermined second loss function; and
determining a network parameter affecting the loss value of the generator and the loss value of the discriminator, and optimizing and updating the network parameter by using a predetermined optimizer.

6. The image generation method according to claim 5, wherein after the optimizing and updating the network parameter by using the predetermined optimizer, the method further comprises:
recording a number of times of optimizing and updating by using a predetermined counter;
determining whether the number of times of optimizing and updating satisfies a predetermined target number of times of optimizing; and
terminating the training when the number of times of optimizing and updating satisfies the predetermined target number of times of optimizing.

7. The image generation method according to claim 1, wherein the acquiring the weakly correlated image-text data pairs comprises:
acquiring information about public social networking websites, and determining a target website based on the information about public social networking websites; and
crawling weakly correlated image-text data in the target website, and generating weakly correlated image-text data pairs based on the weakly correlated image-text data.

8. The image generation method according to claim 1, wherein after the obtaining the trained image generation model, the method further comprises:
testing the trained image generation model based on the weakly correlated image-text data pairs in the image-text dataset; and
after the trained image generation model passes the testing, generating the image corresponding to the to-be-processed text data by using the trained image generation model when the to-be-processed text data is acquired.

9. The image generation method according to claim 1, wherein after the creating the image-text dataset based on the weakly correlated image-text data pairs and before the training the image generation model pre-constructed based on the adversarial network by using the image-text dataset, the method further comprises:
expanding the image-text dataset based on a knowledge-graph technique of a knowledge base.

10. The image generation method according to claim 4, wherein the inputting the predetermined random noise, the text semantic embedding and the entity semantic embedding into the predetermined multilayer perceptron to obtain the affine transformation parameter comprises:
connecting the predetermined random noise, the text semantic embedding and the entity semantic embedding based on a predetermined connection function; and
inputting the predetermined random noise, the text semantic embedding and the entity semantic embedding which are connected into the predetermined multilayer perceptron to obtain the affine-transformation parameter.

11. The image generation method according to claim 3, wherein the constructing the corresponding entity candidate set based on the to-be-expanded entity and the target entity comprises:
combining the target entity and the to-be-expanded entity, to obtain an entity candidate set.

12. The image generation method according to claim 4, wherein the adjusting the current hidden-layer feature value to the target hidden-layer feature value comprises:
directly modifying the current hidden-layer feature value to the target hidden-layer feature value.

13. The image generation method according to claim 4, wherein the determining a target hidden-layer feature value based on the affine transformation parameter, and adjusting a current hidden-layer feature value to the target hidden-layer feature value, to obtain a global condition for constraining a pixel value of the generated first target image comprises:
constraining the pixel value of the first target image based on a norm loss function.

14. The image generation method according to claim 5, wherein the optimizing and updating the network parameter by using the predetermined optimizer comprises:
performing reverse gradient optimization on the network parameter by using the predetermined optimizer.

15. The image generation method according to claim 6, wherein the method further comprises:
when the number of times of optimizing and updating does not satisfy the predetermined target number of times of optimizing, calculating the loss value of the generator based on the predetermined batch size of text, the image corresponding to the text and the entity candidate set corresponding to the text by using the predetermined first loss function, until the number of times of the optimizing and updating satisfies the predetermined target number of times of optimizing.

16. The image generation method according to claim 7, wherein the acquiring the information about public social networking websites comprises:
acquiring a website link of public social networking websites.

17. (canceled)

18. An electronic device, comprising a processor and a memory, wherein the processor executes a computer program stored in the memory to implement the image generation method according to claim 1.

19. A non-transitory readable storage medium, wherein the non-transitory readable storage medium is configured for storing a computer program, and the computer program, when executed by a processor, implements the image generation method according to claim 1.

20. A computer program, wherein the computer program comprises computer-readable codes, which, when executed by a computer processing device, cause the computer processing device to implement the image generation method according to claim 1.

21. The image generation method according to claim 10, wherein the predetermined connection function comprises a concatenate function and a concat function.
